(19) United States
(12) Patent Application Publication
(10) Pub. No.: US 2010/0246493 A1
(43) Pub. Date: Sep. 30, 2010

(54) CONTROL APPARATUS, CONTROL METHOD FOR CONTROLLING APPARATUS, AND PROGRAM

(75) Inventor: Koji Yukimasa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/730,981

(22) Filed: Mar. 24, 2010

(30) Foreign Application Priority Data
Mar. 27, 2009 (JP) 2009-079404

(51) Int. Cl. H04W 40/00; H04B 7/00

(52) U.S. Cl. 370/328; 455/41.2

(57) ABSTRACT

A control apparatus communicable with a plurality of controlled apparatuses includes an acquisition unit configured to acquire information about a communication apparatus within a communication range of the controlled apparatus and information about other communication apparatuses within a communication range of the communication apparatus, and a selection unit configured to select the controlled apparatus that transmits a synchronization signal for synchronization based on the information acquired by the acquisition unit.

### BACKGROUND OF THE INVENTION

1. Field of the Invention

The present invention relates to a communication control technique for making communication between a control apparatus and a controlled apparatus.

2. Description of the Related Art

In recent years, there has been developed wireless communication via wireless universal serial bus (referred to as WUSB below) conforming to WiMedia protocol.

A host as a control apparatus and a device as a controlled apparatus are defined in WUSB. The host includes a self beaconing device (SBD) that autonomously transmits a beacon conforming to the WiMedia protocol. The device includes a directed beaconing device (DBD) that transmits a beacon in response to an instruction from the host and a non-beaconing device (NBD) that does not transmit a beacon.

The DBD can synchronize with other devices by transmitting a beacon in response to a request (transmit packet) from the host. In addition, the DBD can receive a beacon from a surrounding device in response to an instruction (capture packet) from the host and can transmit information about the received beacon to the host.

However, the WUSB have not defined how the host transmits a beacon to the DBD under which condition. Therefore, the host may request even an unnecessary DBD to transmit a beacon when the host synchronizes networks. If an unnecessary DBD is requested to transmit a beacon, a communication band is weighed.

### SUMMARY OF THE INVENTION

According to an aspect of the present invention, a control apparatus communicable with a plurality of controlled apparatuses includes an acquisition unit configured to acquire information about a communication apparatus within a communication range of the controlled apparatus and information about other communication apparatuses within a communication range of the communication apparatus, and a selection unit configured to select the controlled apparatus that transmits a synchronization signal for synchronization based on the information acquired by the acquisition unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are system configuration diagrams.

FIG. 2 is a hardware configuration diagram.

FIG. 3 is a software configuration diagram.

FIGS. 4A and 4B are operation sequence charts.

FIG. 5 is a flowchart illustrating processing executed by a host.

FIG. 6 is a flowchart illustrating processing executed when the host selects a DBD as transmission destination of a transmit packet command.

FIGS. 7A to 7E illustrate examples of group classification.

FIGS. 8A and 8B are flowcharts illustrated processing for selecting a DBD based on the classification.

FIGS. 9A and 9B illustrate a correspondence relationship between a DBD and a group.

### DESCRIPTION OF THE EMBODIMENTS

Various exemplary embodiments, features, and aspects of the invention will be described in detail below with reference to the drawings.

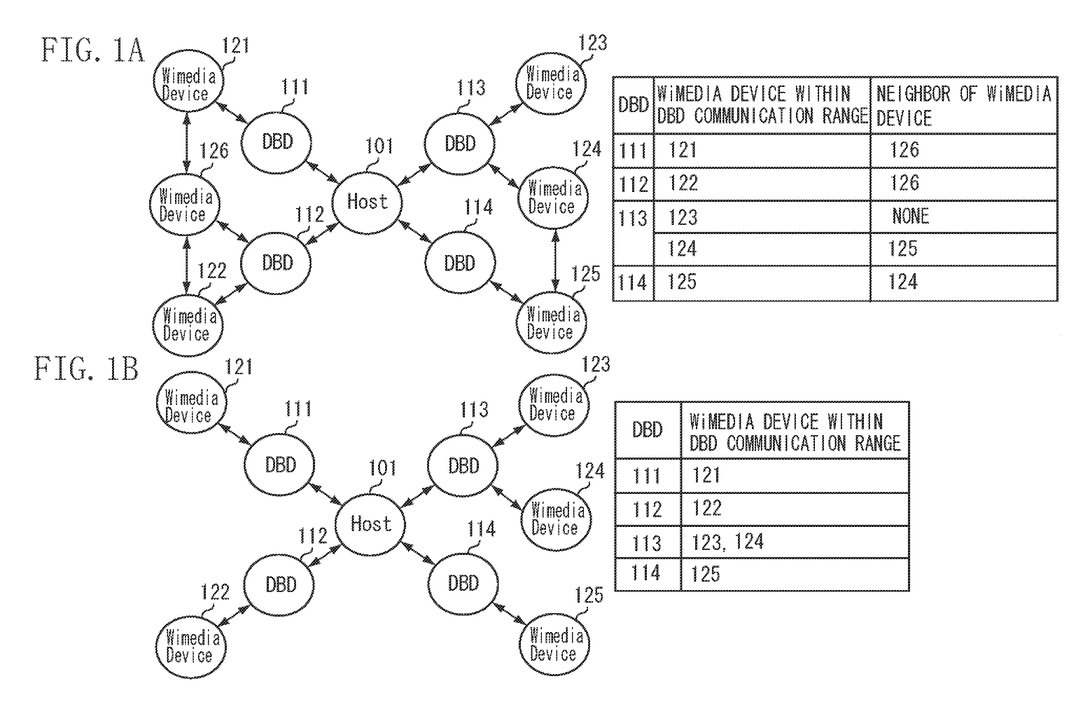

FIG. 1A is a system configuration diagram according to an exemplary embodiment. FIG. 1B will be described below.

A host 101 is a control apparatus. Each of DBDs 111 to 114 is a controlled apparatus. Each of WiMedia devices 121 to 126 is a communication apparatus.

The host 101, the DBDs 111 to 114 and the WiMedia devices 121 to 126 communicate with each other in the distributed reservation protocol (DRP) system conforming to WiMedia protocol. The DRP system is configured such that an apparatus that will transmit data reserves a medium access slot (MAS) in advance, and the apparatus can transmit the data only in a predetermined period of time of the reserved MAS.

In FIG. 1A, a bidirectional arrow indicates that the host, the DBDs and the WiMedia devices are present within a communication range and can communicate with each other. For example, the host 101 and the WiMedia device 121 are present within the communication range of the DBD 111. “Within the communication range” indicates that a notification signal (a beacon conforming to the WiMedia protocol) transmitted by one part can be received by the other part.

Other communication apparatuses (WiMedia devices) which are within the communication range of the WiMedia device and are synchronized with each other are referred to as a neighbor of the WiMedia device. For example, the WiMedia device 122 is the neighbor of the WiMedia device 126. A WiMedia device and its neighbor can synchronize with each other by transmitting a beacon to each other. In other words, the beacon serves as a synchronization signal.

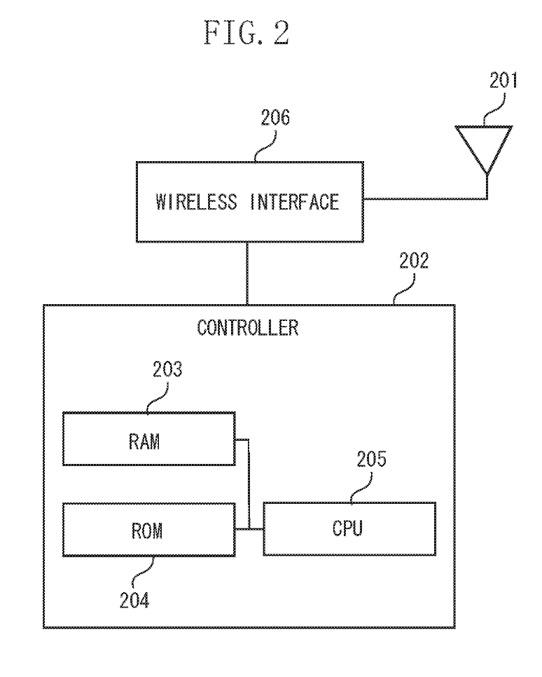

FIG. 2 is a block diagram illustrating a hardware configuration in a wireless unit of the host 101. Only the blocks associated with the present invention are illustrated and other configurations are omitted in FIG. 2. The DBDs 111 to 114 and the WiMedia devices 121 to 126 also have a similar hardware configuration.

An antenna 201 performs transmission and reception of a signal for wireless communication. A controller 202 controls the wireless communication. The controller 202 includes a random access memory (RAM) 203, a read-only memory (ROM) 204 and a central processing unit (CPU) 205. The CPU 205 reads and executes a wireless communication control program stored in the ROM 204 to control the wireless communication. The RAM 203 is used as a storage area when the CPU 205 performs processing.

A wireless interface 206 converts a signal transmitted and received by the antenna 1 to a digital signal processable in the controller 202. The wireless interface 206 also converts the digital signal processable in the controller 202 to a signal to be transmitted and received by the antenna 201.

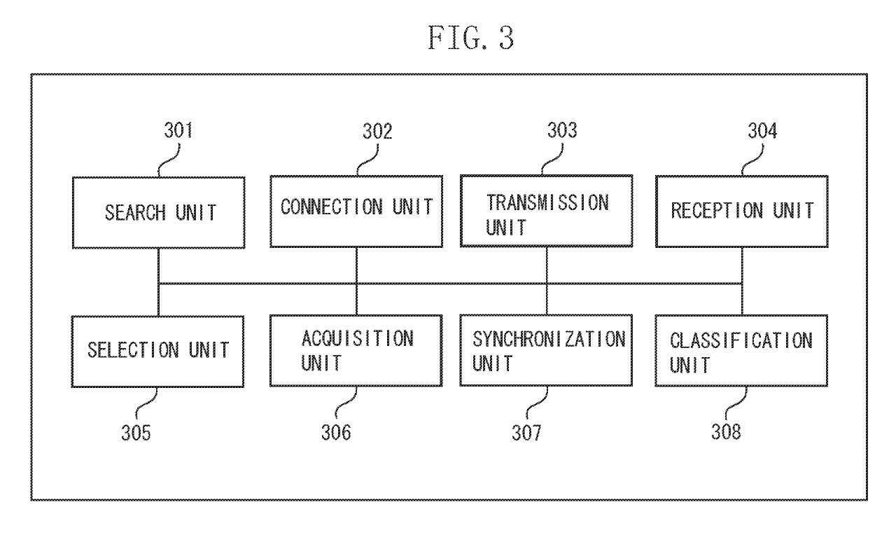

FIG. 3 is a software configuration diagram of the host 101. Only the blocks associated with the present invention are illustrated and other configurations are omitted in FIG. 3. The CPU 205 reads the wireless communication control program stored in the ROM 204 so that the software illustrated in FIG. 3 is executed.

A search unit 301 searches for a DBD present within the communication range. A connection unit 302 makes wireless connection with the DBD or WiMedia device. A transmission unit 303 transmits a command for various requests to the DBD. A reception unit 304 receives information about the WiMedia device or information about a packet transmitted by the WiMedia device.

A selection unit 305 selects a DBD that transmits a command by the transmission unit 303. An acquisition unit 306 analyzes the packet information received by the reception unit 304 and acquires information included in the packet. A synchronization unit 307 synchronizes with the DBD or WiMedia device. A classification unit 308 classifies the WiMedia device into a group.

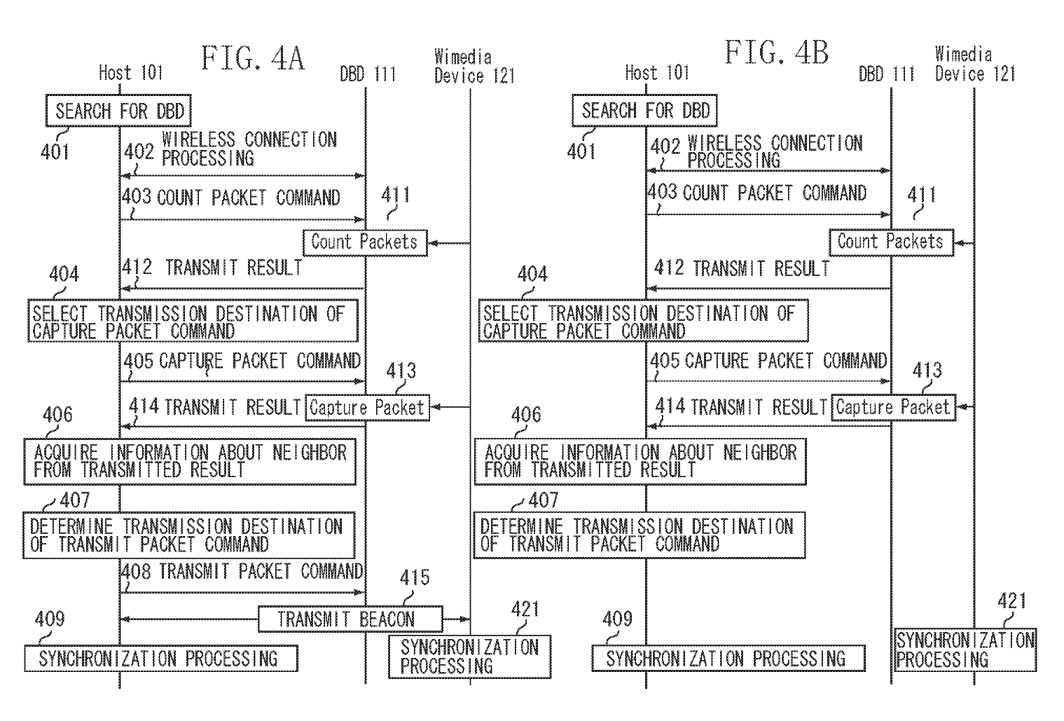

FIG. 4A illustrates an operation sequence chart between the host 101, the DBD 111 and the WiMedia device 121 according to the present exemplary embodiment. FIG. 4B illustrates an operation sequence chart between the host 101, the DBD 112 and the WiMedia device 122 according to the present exemplary embodiment. An operation sequence chart between the host 101, the DBD 113 and the WiMedia device 123 is the same as FIG. 4A. An operation sequence chart between the host 101, the DBD 113 and the WiMedia device 124 is the same as FIG. 4A. Further, an operation sequence chart between the host 101, the DBD 114 and the WiMedia device 125 is the same as FIG. 4B.

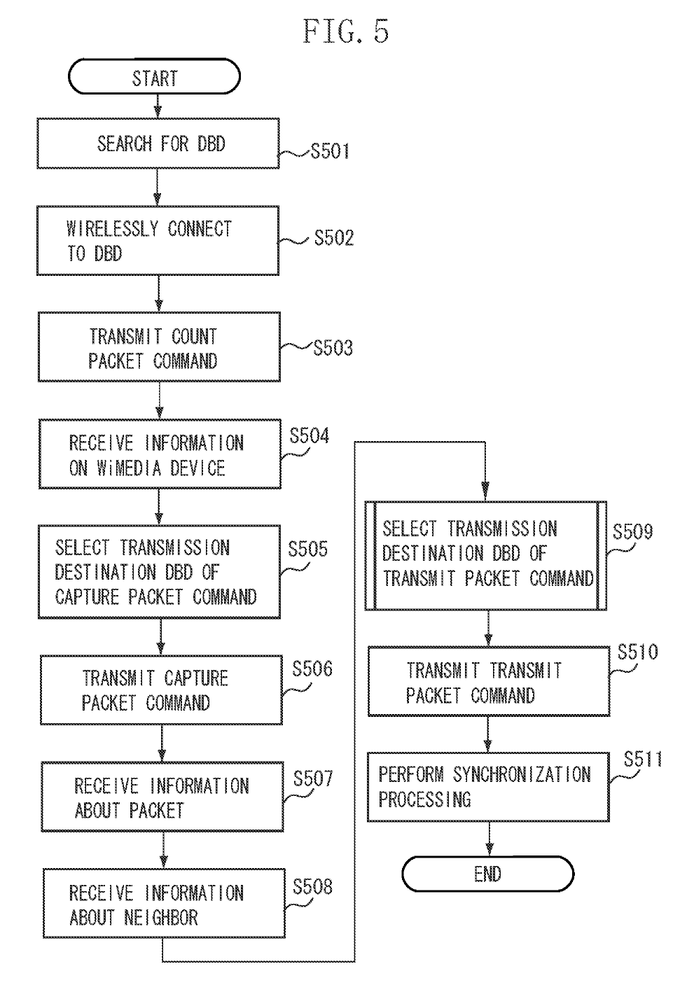

FIG. 5 is a flowchart illustrating processing executed by the CPU 205 according to the present exemplary embodiment by reading the wireless communication control program stored in the ROM 204.

In step S501, the search unit 301 searches for a DBD present within the communication range in response to an instruction of the CPU 205 (401). Here, it can be seen from the searching that the DBDs 111 to 114 are present.

In step S502, the connection unit 302 makes wireless connection with the DBDs present within the communication range in response to an instruction of the CPU 205 (402). Here, the connection unit 302 in the host 101 makes wireless connection with the DBDs 111 to 114, respectively.

In step S503, the transmission unit 303 transmits a count packet command to the DBDs (111 to 114) connected in step S502 in response to an instruction of the CPU 205 (403).

The DBDs 111 to 114 that have received the count packet command monitor a medium access control (MAC) header of all the packets for a certain period of time and thus recognize the WiMedia devices present within the communication range. For example, the DBD 111 recognizes that the WiMedia device 121 is present within the communication range.

Thereafter, the DBDs 111 to 114 transmit the information about the WiMedia device which is recognized as present within the communication range to the host 101 (412). For example, the DBD 111 transmits the information about the WiMedia device 121 to the host 101.

In step S504, the reception unit 304 receives information 412 about the WiMedia device transmitted from the DBD in response to an instruction of the CPU 205.

The host 101 can recognize connection relationships among the DBDs 111 to 114 and the WiMedia devices 121 to 125 as illustrated in FIG. 1B in the above described manner.

In step S505, the selection unit 305 selects a DBD for which a WiMedia device is present within the communication range in response to an instruction of the CPU 205 (404). Here, since the WiMedia device is present within the communication range for each of the DBDs 111 to 114, all the DBDs 111 to 114 are selected.

In step S506, the transmission unit 303 transmits a capture packet command to the DBD selected in step S505 in response to an instruction of the CPU 205 (405). Here, the capture packet command is transmitted to all the DBDs 111 to 114.

The DBD which has received the capture packet command captures a packet transmitted by the WiMedia device present within the communication range for a certain period of time (413). For example, the DBD 111 captures a packet transmitted by the WiMedia device 121 for a certain period of time.

Thereafter, the DBD transmits information about the captured packet to the host 101 (414). Here, the information about the packet captured by each of the DBDs 111 to 114 is transmitted to the host 101.

In step S507, the reception unit 304 receives the information about the packet captured by the DBD in response to an instruction of the CPU 205.

In step S508, the acquisition unit 306 acquires information about the neighbor of the WiMedia device from the information about the packets received in step S507 in response to an instruction of the CPU 205 (406). More specifically, the acquisition unit 306 acquires the information about the neighbor of the WiMedia device from a beacon period occupancy information element (BPOIE) included in the beacon out of the received packet.

For example, the host 101 can recognize that the WiMedia device 126 is present as the neighbor of the WiMedia device 121 from the information about the packet captured by the DBD 111.

As described above, the host 101 can recognize the connection relationships among the DBDs 111 to 114 and the WiMedia devices 121 to 126 as illustrated in FIG. 1A.

In step S509, the selection unit 305 selects a DBD as a transmission destination of the transmit packet command as described below in response to an instruction of the CPU 205 (407). Here, it is assumed that the DBDs 111 and 113 are selected as the transmission destination of the transmit packet command. The DBD which has receives the transmit packet command transmits a beacon.

In step S510, the transmission unit 303 transmits the transmit packet command to the DBD selected in step S509 in response to an instruction of the CPU 205 (408). Here, the transmit packet command is transmitted to the DBDs 111 and 113 and the transmit packet command is not transmitted to the DBDs 112 and 114.

The DBD which has received the transmit packet command from the host 101 transmits a beacon (415). For example, the beacon which has been transmitted by the DBD 111 is received by the host 101 and the WiMedia device 121.

In step S511, the synchronization unit 307 performs synchronization processing which is defined by the WiMedia based on the received beacon in response to an instruction of the CPU 205 (409, 421).

For example, the host 101 and the WiMedia device 121 can synchronize with each other in this manner. Since the WiMedia device 126 is the neighbor of the WiMedia device 121, the WiMedia device 126 can synchronize with the WiMedia device 121. Thus, the WiMedia device 126 can also synchronize with the host 101.

The WiMedia devices 122 and 126 are each other's neighbor and synchronize with each other. Thus, the WiMedia device 122 can also synchronize with the host 101.

The host, the DBD, the WiMedia device and the neighbor can remain synchronized in the above manner. The above described sequence is executed per certain period of time or depending on a change in a status of the network. Thus, even when the status of the network changes, the host, the DBD, the WiMedia device and the neighbor can remain synchronized.

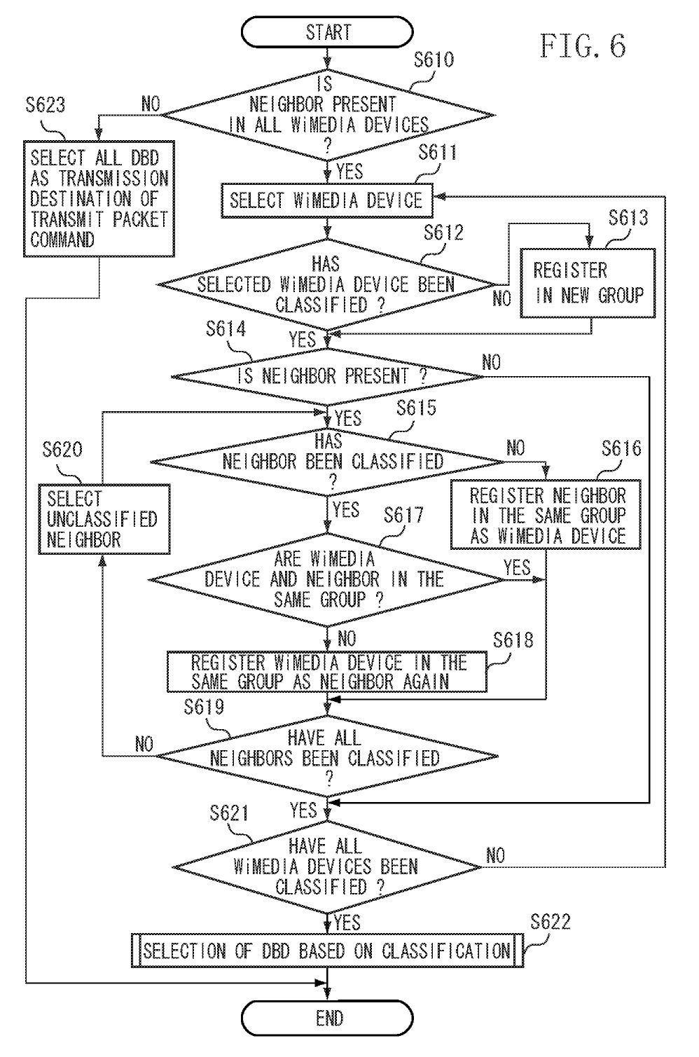

FIG. 6 is a flowchart illustrating processing executed when the host 101 selects a DBD as a transmission destination of a transmit packet command. The flowchart is executed by the CPU 205 by reading the wireless communication control program stored in the ROM 204.

In step S610, the classification unit 308 determines whether a neighbor is present for all the WiMedia devices present within the communication range of the DBD in response to an instruction of the CPU 205. When a neighbor is present (YES in step S610), the procedure proceeds to step S611. When a neighbor is not present (NO in step S610), the procedure proceeds to step S623 and the classification unit 308 selects all the DBDs as the transmission destination of the transmit packet command in response to an instruction of the CPU 205.

Thus, the host 101 can select the transmission destination of the transmit packet command without performing the processing in steps S611 to S622. Therefore, a processing load of the host 101 can be reduced.

Since the WiMedia device 126 is present as the neighbor of the WiMedia device 121, the procedure proceeds to step S611.

In step S611, the classification unit 308 selects one unclassified WiMedia device from among the WiMedia devices (121 to 125) present within the communication range of the DBD in response to an instruction of the CPU 205. It is assumed that the WiMedia device 121 is selected.

In step S612, the classification unit 308 determines whether the WiMedia device selected in step S611 has been already classified in response to an instruction of the CPU 205. If classified (YES in step S612), the procedure proceeds to step S614, and if not classified (NO in step S612), the procedure proceeds to step S613. Here, it is determined that the WiMedia device 121 has not been classified, and the procedure proceeds to step S613.

In step S613, the classification unit 308 registers the WiMedia device selected in step S611 in a new group in response to an instruction of the CPU 205. Here, the WiMedia device 121 is registered in a group 1.

In step S614, the classification unit 308 determines whether a neighbor is present for the WiMedia device selected in step S611 in response to an instruction of the CPU 205. When a neighbor is present (YES in step S614), the procedure proceeds to step S615, and when a neighbor is not present (NO in step S614), the procedure proceeds to step S621. Here, since the WiMedia device 126 is present as the neighbor of the WiMedia device 121, the procedure proceeds to step S615.

In step S615, the classification unit 308 determines whether one present neighbor has been already classified in response to an instruction of the CPU 205. If classified (YES in step S615), the procedure proceeds to step S617, and if not classified (NO in step S615), the procedure proceeds to step S616. Here, it is determined that the WiMedia device 126 as the neighbor of the WiMedia device 121 has not been classified, and the procedure proceeds to step S616.

In step S616, the classification unit 308 registers the neighbor determined in step S615 in the same group as the WiMedia device selected in step S611 in response to an instruction of the CPU 205. Here, since the WiMedia device 121 is registered in the group 1, the WiMedia device 126 is also registered in the group 1. Thereafter, the procedure proceeds to step S619.

In step S617, the classification unit 308 determines whether the WiMedia device selected in step S611 and the neighbor determined in step S615 are registered in the same group in response to an instruction of the CPU 205. If registered in the same group (YES in step S617), the procedure proceeds to step S619, and if registered in different groups (NO in step S617), the procedure proceeds to step S618.

In step S618, the classification unit 308 registers the WiMedia device selected in step S611 in the group of the neighbor determined in step S615 again in response to an instruction of the CPU 205. In other words, the WiMedia device selected in step S611 is deleted from the registered group and is registered in the group of the neighbor determined in step S615 again.

In step S619, the classification unit 308 determines whether the neighbors for all the WiMedia devices selected in step S611 have been classified in response to an instruction of the CPU 205. If classified (YES in step S619), the procedure proceeds to step S621, and if not classified (NO in step S619), the procedure proceeds to step S620. Here, since the WiMedia device 126 as the neighbor of the WiMedia device 121 has been classified, the procedure proceeds to step S621.

In step S620, the classification unit 308 selects the unclassified neighbor and the procedure proceeds to step S615 in response to an instruction of the CPU 205. In step S621, the classification unit 308 determines whether the WiMedia device present within the communication range of the DBD has been classified in response to an instruction of the CPU 205. If not classified (NO in step S621), the procedure proceeds to step S611. Here, since the WiMedia devices 122 to 125 have not been classified, the procedure proceeds to step S611.

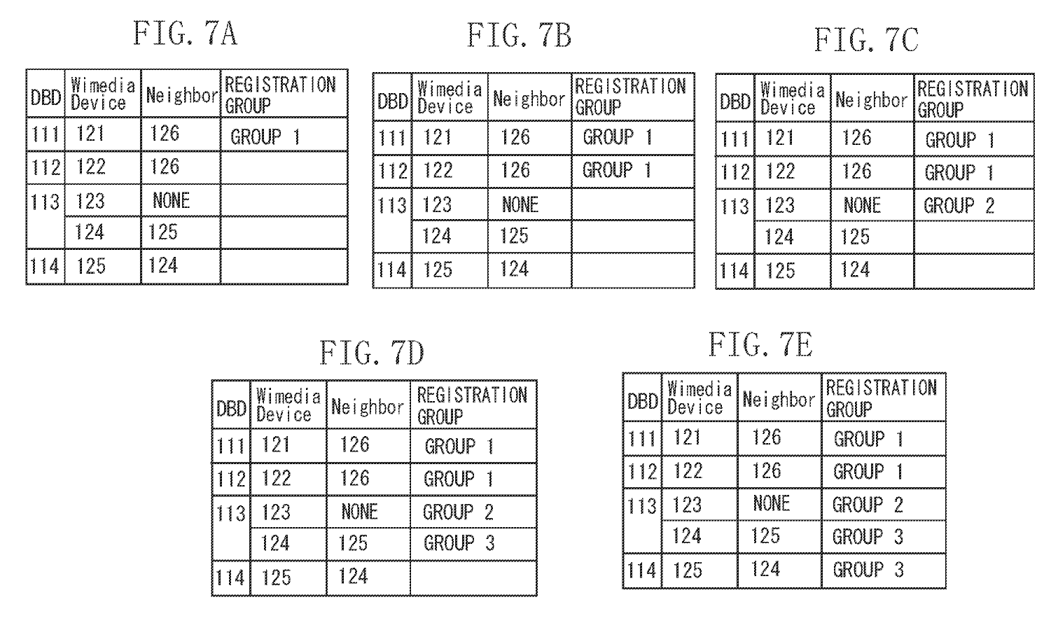

As described above, the WiMedia devices can be classified as illustrated in FIG. 7A.

The classification of other WiMedia devices according to the present exemplary embodiment will be described below in brief with reference to the flowchart of FIG. 6.

In step S611, the classification unit 308 selects the WiMedia device 122. In step S612, the classification unit 308 determines that the WiMedia device 122 has not been classified, and the procedure proceeds to step S613. In step S613, the classification unit 308 registers the WiMedia device 122 in a group 2.

In step S614, the classification unit 308 determines that the WiMedia device 126 is present as the neighbor of the WiMedia device 122, and the procedure proceeds to step S615. In step S615, the classification unit 308 determines that the WiMedia device 126 has been already classified into the group 1, and the procedure proceeds to step S617.

In step S617, the classification unit 308 determines whether the WiMedia device 122 and the WiMedia device 126 as the neighbor of the WiMedia device 122 are registered in different groups. Since the WiMedia device 122 is registered in the group 1 and the WiMedia device 126 is registered in the group 1, both the WiMedia device 122 and the WiMedia device 126 are determined to be registered in different groups, and the procedure proceeds to step S618.

In step S618, the classification unit 308 registers the WiMedia device 122 in the group 1, not the group 1, again.

In step S619, the classification unit 308 determines that all the neighbors of the WiMedia device 122 have been classified, and the procedure proceeds to step S621. In step S621, the classification unit 308 determines that the WiMedia devices 123 to 125 have not been classified, and the procedure returns to step S611.

The WiMedia devices can be classified as illustrated in FIG. 7B in the above manner.

In step S611, the classification unit 308 selects the WiMedia device 123. In step S612, the classification unit 308 determines that the WiMedia device 123 has not been classified, and the procedure proceeds to step S613. In step S613, the classification unit 308 registers the WiMedia device 123 in the group 1.

In step S614, the classification unit 308 determines that a neighbor of the WiMedia device 123 is not present, and the procedure proceeds to step S621. In step S621, the classification unit 308 determines that the WiMedia devices 124 and 125 have not been classified, and the procedure returns to step S611.

The WiMedia devices can be classified as illustrated in FIG. 7C in the above manner.

In step S611, the classification unit 308 selects the WiMedia device 124. In step S612, the classification unit 308 determines that the WiMedia device 124 has not been classified, and the procedure proceeds to step S613. In step S613, the classification unit 308 registers the WiMedia device 124 in a group 3.

In step S614, the classification unit 308 determines that the WiMedia device 125 is present as the neighbor of the WiMedia device 124, and the procedure proceeds to step S615. In step S615, the classification unit 308 determines that the WiMedia device 125 has not been classified, and the procedure proceeds to step S616.

In step S616, the classification unit 308 registers the WiMedia device 125 in the same group 3 as the WiMedia device 124.

In step S619, the classification unit 308 determines that all the neighbors of the WiMedia device 124 have been classified, and the procedure proceeds to step S621. In step S621, the classification unit 308 determines that the WiMedia device 125 has not been classified, and the procedure returns to step S611.

The WiMedia devices can be classified as illustrated in FIG. 7D in the above manner.

In step S611, the classification unit 308 selects the WiMedia device 125. In step S612, the classification unit 308 determines that the WiMedia device 125 has been classified, and the procedure proceeds to step S614.

In step S614, the classification unit 308 determines that the WiMedia device 125 is present as the neighbor of the WiMedia device 124, and the procedure proceeds to step S615. In step S615, the classification unit 308 determines that the WiMedia device 125 has been classified (registered in the group 3), and the procedure proceeds to step S617.

In step S617, the classification unit 308 determines that the WiMedia device 125 and the WiMedia device 124 as the neighbor of the WiMedia device 125 are registered in the same group 3, and the procedure proceeds to step S619.

In step S619, the classification unit 308 determines that all the neighbors of the WiMedia device 125 have been classified, and the procedure proceeds to step S621. In step S621, the classification unit 308 determines that all the WiMedia devices 121 to 125 have been classified, and the procedure proceeds to step S622.

The WiMedia devices can be classified as illustrated in FIG. 7E in the above manner.

As described above, the communication apparatuses that have other common communication apparatus within the communication range can be classified into the same group.

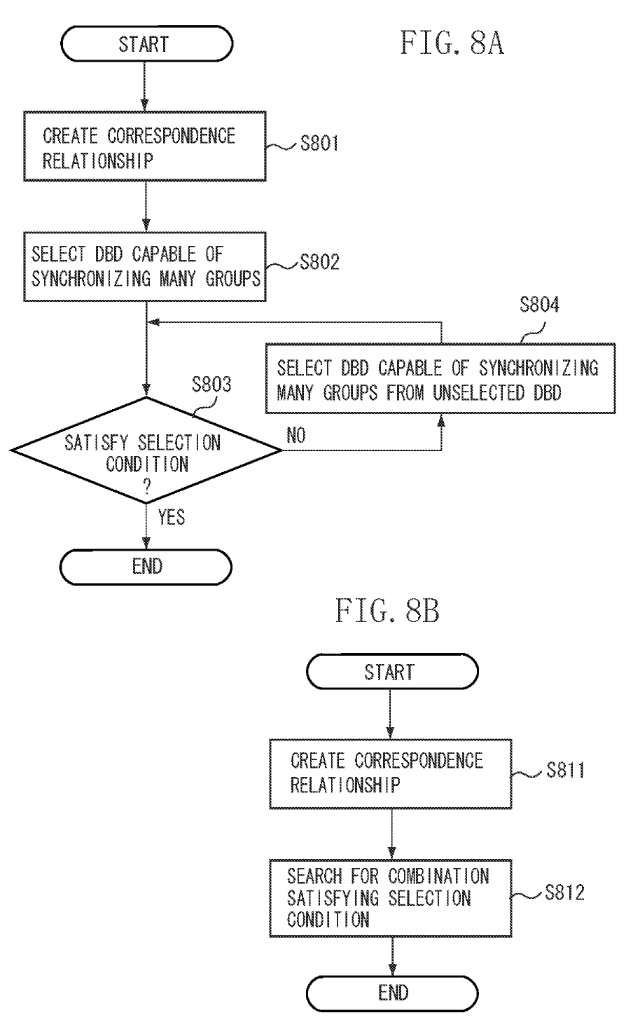

Next, a flowchart in FIG. 8A illustrating a detail of the processing in step S622 will be described below.

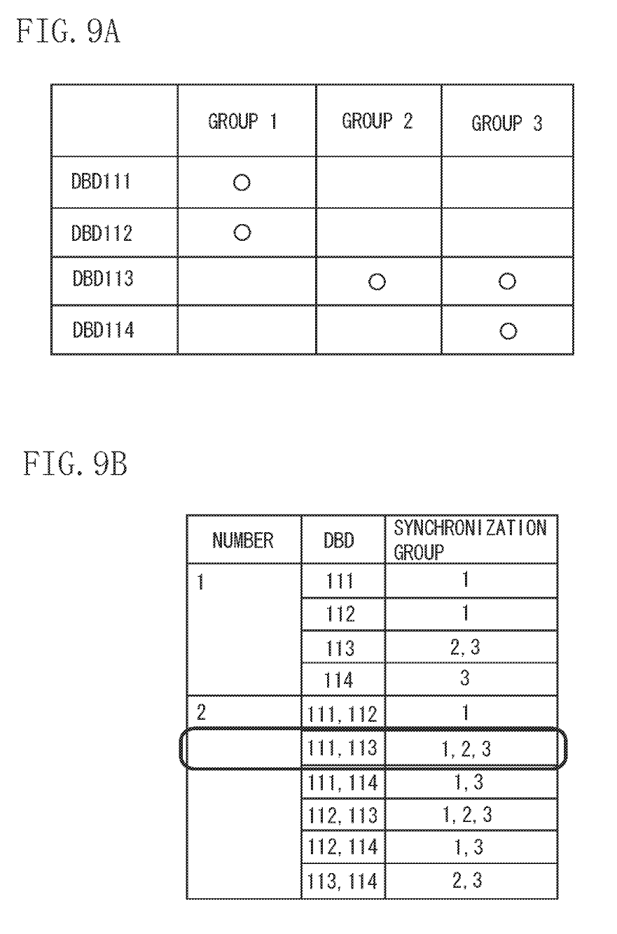

In step S801, the selection unit 305 creates a correspondence relationship between a DBD that transmits a beacon and a group that can be synchronized therewith by transmission of the beacon based on classification results in steps S610 to 621 and 623 in response to an instruction of the CPU 205. An example of a table of the correspondence relationship created based on FIG. 7E is illustrated in FIG. 9A.

In step S802, the selection unit 305 selects the DBD which has the most synchronizable groups from the correspondence relationship between the DBD and the group in response to an instruction of the CPU 205. If there are present the DBDs that have the same number of synchronizable groups, either one thereof is selected. Here, the DBD 113 is selected.

In step S803, the selection unit 305 transmits a transmit packet to the selected DBD to thereby determine whether a selection condition is satisfied in response to an instruction of the CPU 205. If the selection condition is not satisfied (NO in step S803), the procedure proceeds to step S804. Here, the selection condition is defined as being synchronized with all the groups. However, the selection condition is not limited to the above, for example, there may be employed a selection condition that as many DBDs as possible are used for an arbitrary WiMedia device for synchronization or a selection condition that synchronization is established with an arbitrary WiMedia device.

Here, synchronization cannot be established in the group 1 by only the DBD 113 and thus the procedure proceeds to step S804.

In step S804, the selection unit 305 selects the DBD except for the already-selected DBDs as the next DBD in response to an instruction of the CPU 205. The DBD which has the most synchronizable groups except for the groups which can synchronize with the already-selected DBD is selected from among the selection candidates. When the DBDs which have the same number of synchronizable groups are present, either one of them is selected. Here, the DBD 111 is selected.

After the DBD is selected, the procedure proceeds to step S803. The DBD is sequentially selected in the above manner.

In the present exemplary embodiment, since the selection condition is satisfied in a state where the DBDs 111 and 113 are selected, the transmission destination of the transmit packet is determined as the DBDs 111 and 113.

A flowchart indicating a detail of the processing in step S622 can be illustrated in FIG. 8B.

In step S811, the selection unit 305 creates a correspondence relationship between a DBD that transmits a beacon and a group that can be synchronized therewith by transmission of the beacon based on the classification result in step S601 in response to an instruction of the CPU 205. An example of a table of the correspondence relationship created based on FIG. 7E is illustrated in FIG. 9B.

In step S812, the selection unit 305 searches for a combination which satisfies the selection condition from the correspondence relationship between the DBD and the group in response to an instruction of the CPU 205. If a plurality of combinations have been found, one of them is selected. Here, there is defined a selection condition that all the groups are synchronized. In this case, a combination of the DBDs 111 and 113 is selected.

A transmit packet is transmitted only to the DBD selected in the above manner to transmit a beacon, so that the processing load of the host can be reduced. Further, a beacon is transmitted only to the selected DBD, so that an occupation time by the beacon is reduced and the communication band can be efficiently used. Furthermore, since the number of beacons to be received by the WiMedia device is reduced, power consumption of the WiMedia device can be reduced.

A beacon is transmitted only to the selected DBD, so that a beacon period is shortened. The WiMedia device can recognize the beacon period and change time for listening to the beacon according to the recognized beacon period. Thus, the power consumption of the WiMedia device can be further reduced. Particularly, this is significantly effective since the power consumption of the WiMedia device for listening to a beacon is large.

The present invention may provide a recording medium including program codes of software for realizing the above described functions recorded therein to a system or an apparatus, and a computer (CPU, micro processing unit (MPU)) in the system or the apparatus may read and execute the program codes stored in the recording medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-079404 filed Mar. 27, 2009, which is hereby incorporated by reference herein in its entirety.

What is claimed is:

1. A control apparatus communicable with a plurality of controlled apparatuses, the control apparatus comprising:
an acquisition unit configured to acquire information about a communication apparatus within a communication range of the controlled apparatus and information about other communication apparatuses within a communication range of the communication apparatus; and
a selection unit configured to select the controlled apparatus that transmits a synchronization signal for synchronization based on the information acquired by the acquisition unit.

2. The control apparatus according to claim 1, further comprising
a classification unit configured to classify a plurality of communication apparatuses into groups based on the information acquired by the acquisition unit,
wherein the selection unit selects the controlled apparatus based on the classification by the classification unit.

3. The control apparatus according to claim 2,
wherein the classification unit classifies the communication apparatuses which include other common communication apparatuses within the communication range into a same group.

4. The control apparatus according to claim 2,
wherein the controlled apparatus transmits the synchronization signal, so that the communication apparatuses classified into a same group by the classification unit can synchronize with the control apparatus.

5. The control apparatus according to claim 2,
wherein the selection unit selects the controlled apparatus based on a number of groups which can be synchronized by the controlled apparatus transmitting the synchronization signal.

6. The control apparatus according to claim 5,
wherein the selection unit selects the controlled apparatus which enables a large number of groups to be synchronized by causing the controlled apparatus to transmit the synchronization signal.

7. The control apparatus according to claim 2, further comprising
a determination unit configured to determine a group which can be synchronized by causing the controlled apparatus to transmit the synchronization signal,
wherein the selection unit selects the controlled apparatus based on a result of the determination unit.

8. The control apparatus according to claim 7,
wherein the determination unit determines the group which can be synchronized for each combination of controlled apparatuses transmitting the synchronization signal.

9. The control apparatus according to claim 1,
wherein when the acquisition unit cannot acquire information about other communication apparatuses within the communication range of the communication apparatus, the selection unit selects all the controlled apparatuses.

10. A method for controlling a control apparatus communicable with a plurality of controlled apparatuses, the method comprising:
acquiring information about a communication apparatus within a communication range of the controlled apparatus and information about other communication apparatuses within a communication range of the communication apparatus; and
selecting the controlled apparatus which transmits a synchronization signal for synchronization based on the acquired information.

11. The method according to claim 10, further comprising:
classifying a plurality of communication apparatuses into groups based on the acquired information,
wherein selecting the controlled apparatus is based on the classification.

12. The method according to claim 11, wherein the classifying the communication apparatuses includes classifying other common communication apparatuses within the communication range into a same group.

13. The method according to claim 11, further comprising transmitting the synchronization signal, so that the communication apparatuses classified into a same group can synchronize with the control apparatus.

14. The method according to claim 11, wherein the selecting the controlled apparatus is based on a number of groups which can be synchronized by the controlled apparatus transmitting the synchronization signal.

15. The method according to claim 14, further comprising enabling a large number of groups to be synchronized by causing the transmitting the synchronization signal.

16. The method according to claim 11, further comprising:
determining a group which can be synchronized by causing the controlled apparatus to transmit the synchronization signal,
wherein the selecting the controlled apparatus is based on a determined result.

17. The method according to claim 16, further comprising determining the group which can be synchronized for each combination of controlled apparatuses transmitting the synchronization signal.

18. The method according to claim 10, further comprising selecting all the controlled apparatuses when information about other communication apparatuses within the communication range of the communication apparatus cannot be acquired.

19. A storage medium storing a program for causing a computer to execute a method according to claim 10 therein.

20. The storage medium according to claim 19, further comprising:
classifying a plurality of communication apparatuses into groups based on the acquired information,
wherein the selecting the controlled apparatus is based on the classification.
